(19) United States
(12) Patent Application Publication
(10) Pub. No.: US 2024/0326422 A1
(43) Pub. Date: Oct. 3, 2024

(54) HEAD ASSEMBLY, METHOD FOR CONTROLLING HEAD ASSEMBLY, AND SYSTEM INCLUDING HEAD ASSEMBLY

(71) Applicant: BROTHER KOGYO KABUSHIKI KAISHA, Nagoya (JP)

(72) Inventors: Fumika HATTA, Kuwana (JP); Yuya TSUNEOKA, Nagoya (JP); Kosuke TORIKAI, Nagoya (JP)

(21) Appl. No.: 18/404,556

(22) Filed: Jan. 4, 2024

(30) Foreign Application Priority Data
Mar. 31, 2023 (JP) 2023-059602

(51) Int. Cl. B41J 2/14; B41J 2/045; B41J 11/00; B41J 29/377

(52) U.S. Cl. CPC B41J 2/1408; B41J 2/04536; B41J 2/0458; B41J 2/04581; B41J 2/14072; B41J 2/14201; B41J 11/007; B41J 29/377; B41J 2002/14491

(57) ABSTRACT

A method executable by a controller electrically connected to a head assembly including: a head including pressure generators each having one of a plurality of individual electrodes, a substrate having power sources, and a cooler configured to cool an uppermost power source, a connection destination of each of the plurality of individual electrodes included in one of the pressure generators being one of the power sources, the method including causing a memory provided on the head assembly or a controller electrically connected to the head assembly to store the connection destination of each of the plurality of individual electrodes. In a case that the plurality of individual electrodes is divided into groups each corresponding to the connection destination thereof, making the connection destination corresponding to a group, of the groups, having individual electrodes, of which number is greatest among the plurality of individual electrodes, to be the uppermost power source.

### REFERENCE TO RELATED APPLICATIONS

This application claims priority from Japanese Patent Application No. 2023-059602 filed on Mar. 31, 2023. The entire content of the priority application is incorporated herein by reference.

### BACKGROUND ART

A head assembly includes a head provided with a plurality of pressure generators configured to apply a discharging pressure to a plurality of pressure chambers each of which communicating with one of a plurality of nozzles, and a substrate on which a plurality of power sources is mounted.

### SUMMARY

In the head assembly, the plurality of power sources mounted on the substrate do not have a same heating value. For example, the heating values are different among the plurality of power sources, depending on the number (quantity) of the pressure generator, such as a piezoelectric element, a heater, etc., connected to each of the plurality of power sources, and/or an output voltage from each of the plurality of power sources. In general, it is known that the service life of a power source is affected by the output current and the environmental temperature. Further, the environmental temperature of a certain power sources, among the plurality of power sources, is affected, in some cases, by the heat generated from another power source or sources of the plurality of power sources. In a case that the environmental temperature is not considered, there is such a fear that any variation in the length of the service life might become great among the plurality of power sources.

An object of the present disclosure is to provide a technique for suppressing, in a head assembly having a plurality of power sources mounted on a substrate, any variation in the length of the service life among the plurality of power sources.

According to an aspect of the present disclosure, there is provided a method executable by a controller electrically connected to a head assembly. The head assembly includes: a head; a substrate; and a cooler. The head includes a plurality of pressure generators each of which includes one of a plurality of individual electrodes. The substrate includes a plurality of power sources mounted thereon so that at least power sources, as a part of the plurality of power sources, are located to be dispersed in an up-down direction, the substrate being electrically connected to the head. The cooler is configured to cool an uppermost power source which is included in the plurality of power sources and which is positioned at an uppermost location among the plurality of power sources. A connection destination of each of the plurality of individual electrodes included in one of the plurality of pressure generators is one of the plurality of power sources. The method includes causing a memory provided on a memory provided on the head assembly or a controller electrically connected to the head assembly to store the connection destination of each of the plurality of individual electrodes. The causing the memory to store the connection destination of each of the plurality of individual electrodes includes, in a case that the plurality of individual electrodes is divided into a plurality of groups each corresponding to the connection destination thereof, making the connection destination corresponding to a group, of the plurality of groups, including individual electrodes, of which number is greatest among the plurality of individual electrodes, to be the uppermost power source which is included in the plurality of power sources and which is positioned at the uppermost location among the plurality of power sources.

The heating value of the power source which is connected to the individual electrodes which are included in the plurality of individual electrodes and of which number is greatest among the plurality of individual electrodes becomes to be greatest among the plurality of power sources mounted on the substrate. In the above-described configuration, the controller sets the connection destination so that the individual electrodes of which number is greatest among the plurality of individual electrodes are connected to the power source which is included in the plurality of power sources and which is positioned at the uppermost location among the plurality of power sources. With this, the power source of which heating value becomes to be greatest is positioned at the uppermost location. Since the convected heat is oriented upward, it is possible to suppress the occurrence of such a situation that the convected heat generated from the power source of which heating value becomes to be greatest affects another power source(s) of the plurality of power sources. Further, since the cooler is configured to cool the power source which is positioned at the uppermost location, it is possible to effectively cool the power source of which heating value becomes to be greatest. With this, it is possible to suppress any degradation or deterioration of the power source of which heating value becomes to be greatest, and to suppress any variation in the length of the service life among the plurality of power sources.

### BRIEF DESCRIPTION OF DRAWINGS

FIG. 1 is a schematic plan view of a printing apparatus 1.

FIG. 2 is a schematic view of the printing apparatus 1.

FIG. 3 is a schematic view for explaining an arrangement (alignment) of heads 11 included in a head group 20.

FIG. 4 is a schematic view for explaining the inside of a channel unit 42.

FIG. 5 is a view for schematically explaining a head assembly 10.

FIG. 6A is a top view of a relay substrate 300, and FIG. 6B is a bottom view of the relay substrate 300.

FIG. 7 is an exploded perspective view of a rigid substrate 110.

FIG. 8 is a view for schematically explaining a cooler 600.

FIG. 9 is a view for explaining a channel (flow channel) of cooling water of a water cooling block 610.

FIG. 10 is a view for schematically explaining an operation of a lever 640.

FIG. 11 a view for schematically explaining the operation of the lever 640.

FIG. 12 is a view for explaining the connection between power sources 112a to 112e and individual electrodes 45 of driving elements 46.

FIG. 13 is a flow chart for explaining a connecting processing (power source connecting processing) of the power sources 112a to 112e and the individual electrodes 45 of driving elements 46.

FIG. 14 is a flow chart indicating the detail of a processing of step S10 of FIG. 13.

FIG. 15 indicates a correspondence table, in a case that the individual electrodes 45 are divided into five groups (group 1 to group 5) each corresponding to a connection destination thereof, between the number of individual electrodes 45 included in each of the respective five groups and power sources 112 each of which corresponds to one of the five groups.

### DESCRIPTION

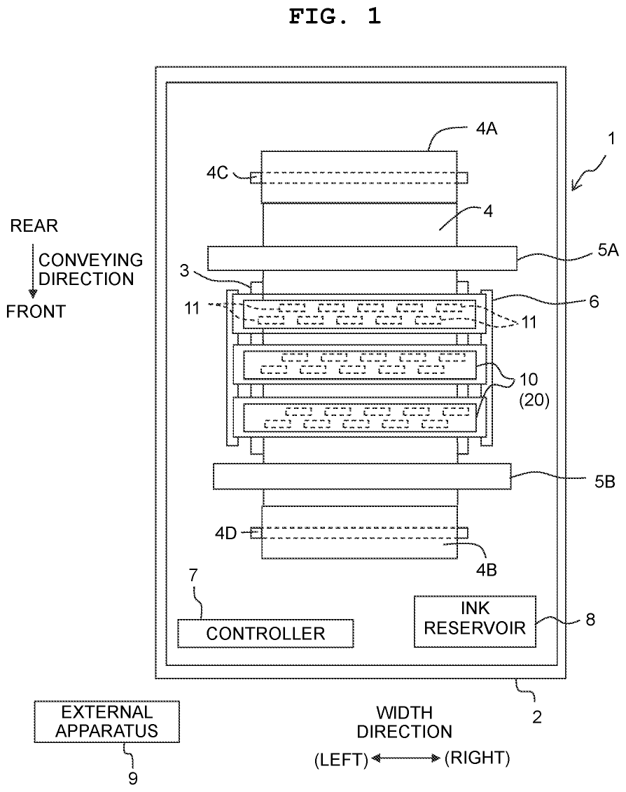

In the following, a printing apparatus 1 according to an embodiment of the present disclosure will be explained, based on the drawings. In FIG. 1, a conveying direction of a recording medium 4 corresponds to a front-rear direction of the printing apparatus 1. Further, a width direction of the recording medium 4 corresponds to a left-right direction of the printing apparatus 1. Furthermore, a direction orthogonal to the front-rear direction and the left-right direction, namely, a direction perpendicular to the sheet surface in FIG. 1 corresponds to an up-down direction of the printing apparatus 1.

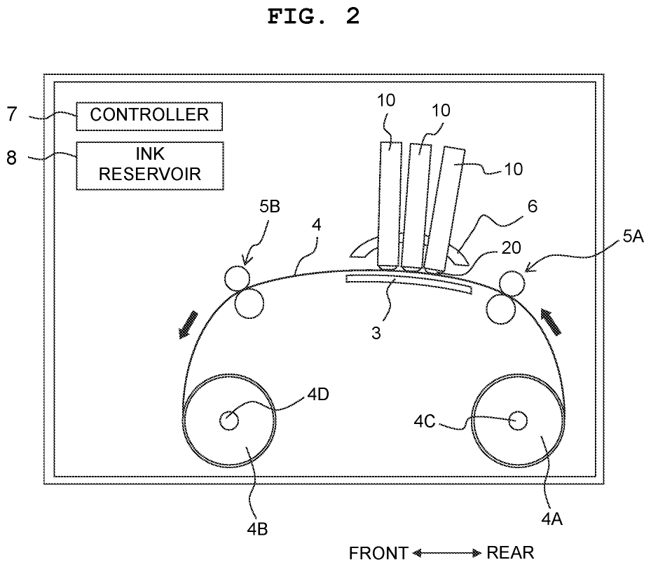

As depicted in FIGS. 1 and 2, the printing apparatus 1 is provided with a platen 3, three head assemblies 10 (each of which is an example of a “head assembly” of the present disclosure), two conveying rollers 5A and 5B, an arch frame 6, a controller 7, five ink reservoirs 8, etc., which are accommodated in a casing 2. Note that in FIGS. 1 and 2, only one reservoir 8 is depicted so as to simplify the drawings.

As depicted in FIGS. 1 and 2, a recording medium 4 is placed on an upper surface of the platen 3. The three head assemblies 10 are positioned, at a location above the platen 3, so as to face the platen 3. An ink is supplied from the ink reservoir(s) 8 to each of the head assemblies 10. The structure of each of the head assemblies 10 will be explained later on. Note that the three head assemblies 10 are fixed to the arch frame 6 in a state that the three head assemblies 10 are arranged side by side along the front-rear direction (the conveying direction of the recording medium 4). As depicted in FIG. 2, the arch frame 6 has an arch shape, and the three head assemblies 10 are arranged so that the three head assemblies 10 are inclined with respect to a horizontal plane at mutually different angles.

As depicted in FIGS. 1 and 2, the two conveying rollers 5A and 5B are arranged, respectively, on the rear side and the front side of the platen 3. The two conveying rollers 5A and 5B are driven by a non-illustrated motor. As depicted in FIG. 2, the recording medium 4 is fed from a feeding roll 4A around which the recording medium 4 is wound in a roll shape, and is wound by a winding roll 4B. For example, it is allowable to use roll paper (roll paper sheet) as the recording medium 4. Rotating shafts 4C and 4D, which are rotated by a non-illustrated motor, are attached to the feeding roll 4A and the winding roll 4B, respectively. These two rotating shafts 4C and 4D and the two conveying rollers 5A and 5B cooperate so as to feed the recording medium 4 from the feeding roll 4A, to convey the recording medium 4 toward the downstream side along the conveying direction (frontward) so that the recording medium 4 passes on the platen 3, and to cause the recording medium 4 to be wound by the winding roll 4B. The two rotating shafts 4C and 4D and the two conveying rollers 5A and 5B are an example of a “conveying mechanism” of the present disclosure.

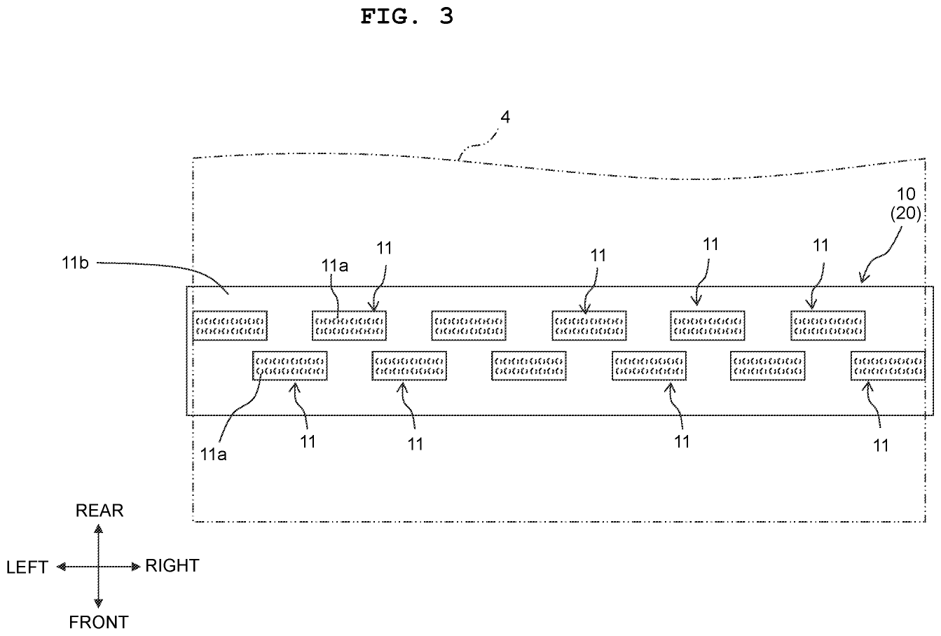

As depicted in FIG. 3, each of the head assemblies 10 is provided with a head group 20 having a plurality of heads 11 (for example, twelve heads 11 in the present embodiment). The plurality of heads 11 constructs two head rows (head arrays) arranged along the front-rear direction. Each of the head rows includes 6 of the heads 11 which are arranged in the left-right direction. Positions in the front-rear direction of the six heads 11 arranged in the left-right direction are same. Note that, however, in the following explanation, the phrase that “the positions are same” does not mean that the positions are same in a strict sense; rather, the phrase intends to mean that the positions are same within a manufacturing error and an attaching error. Note that the positions in the left-right direction of the heads 11 included in the two head rows are shifted from one another. Namely, 12 of the heads 11 of the head group 20 are arranged staggered.

A lower surface of each of the heads 11 is a nozzle surface 11b in which a plurality of nozzles 11a is formed. As depicted in FIG. 3, the plurality of nozzles 11a of each of the heads 11 is aligned in a row form along the left-right direction which is the longitudinal direction of the head group 20 (head assembly 10). Note that, in the present embodiment, although each of the heads 11 is provided with two nozzle rows, this is merely an example and the each of the heads 11 may be provided with not less than two nozzle rows. Further, in FIG. 3, although the number of the nozzles 11a included in each of the nozzle rows is reduced for simplification of the drawing, the number of the nozzles 11a included in each of the nozzle rows may be an arbitrary number. For example, each of the nozzle rows may include not less than 1000 nozzles 11a. Note that although an intra-head channel is formed in the inside of each of the heads 11, the shape, etc., of the intra-head channel will be described later on.

As described above, the twelve heads 11 in each of the head assemblies 10 (head group 20) form the two head rows. As described above, each of the twelve heads 11 has the two nozzle rows. Since it is possible to discharge or eject different color inks from the respective nozzle rows, each of the heads 11 is capable of ejecting two color inks, at most. A white ink is supplied from one of the five ink reservoirs 8 to twelve heads 11 of a head assembly 10 which is arranged on the rearmost side (arranged closest to the upstream side in the conveying direction) among the three head assemblies 10. The white ink is usable for underlayer printing. A yellow ink and a magenta ink are supplied, respectively, from two of the five ink reservoirs 8 to twelve heads 11 of a head assembly 10 which is arranged second from the rear side (second from the upstream side in the conveying direction) among the three head assemblies 10. The yellow ink is ejected from a nozzle row which is arranged on the rear side (the upstream side in the conveying direction) among the two nozzle rows; and the magenta ink is ejected from a nozzle row which is arranged on the front side (the downstream side in the conveying direction) among the two nozzle rows, of each of the heads 11. A cyan ink and a black ink are supplied, respectively, from two of the five ink reservoirs 8 to twelve heads 11 of a head assembly 10 which is arranged on the frontmost side (arranged closest to the downstream side in the conveying direction) among the three head assemblies 10. The cyan ink is ejected from a nozzle row which is arranged on the rear side (the upstream side in the conveying direction) among the two nozzle rows; and the black ink is ejected from a nozzle row which is arranged on the front side (the downstream side in the conveying direction) among the two nozzle rows, of each of the heads 11. In such a manner, the inks are ejected from the three head assemblies 10 which are arranged in the conveying direction in an order of a light (pale) color ink to a deep color ink from the upstream side toward the downstream side in the conveying direction. Note that each of the white ink, the yellow ink, the magenta ink, the cyan ink and the black ink is an UV-curable ink. The viscosity of the UV-curable ink varies or changes greatly depending on the temperature. In order to avoid any unsatisfactory ejection (ejection failure), it is necessary to maintain the viscosity of the ink within an appropriate range. For this purpose, it is necessary to maintain the temperature of the UV-curable ink at an appropriate temperature.

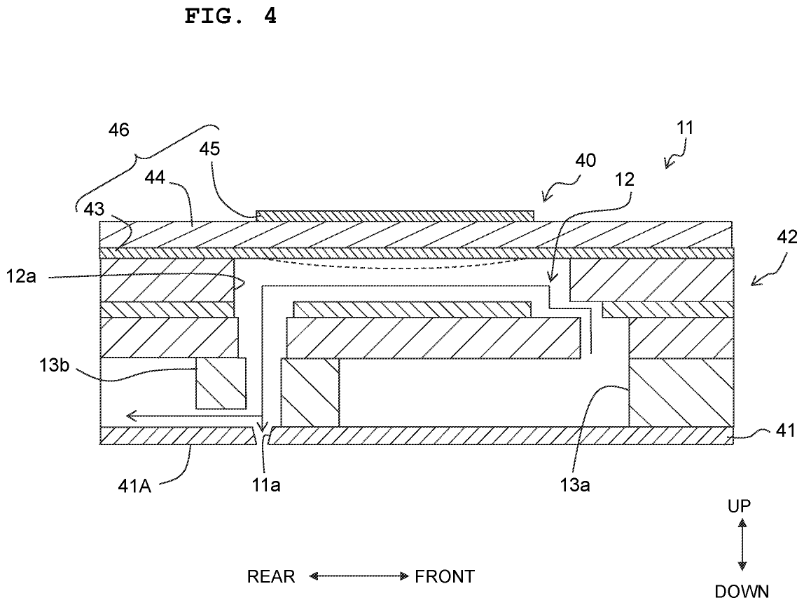

Next, a channel unit 42 and an actuator unit 40 constructing each of the heads 11 will be explained, with reference to FIGS. 3 and 4. Note that since the configurations of the channel unit 42 and the actuator unit 40 are common to the twelve heads 11, the explanation will be given about the channel unit 42 and the actuator unit 40 in one piece of the heads 11.

As depicted in FIG. 4, the channel unit 42 is formed of a plurality of metal plates and a nozzle plate 41 which are stacked in the up-down direction. An ink channel such as an individual channel 12 which includes a pressure chamber 12a, a supply manifold 13a, a return manifold 13b, etc., is formed in the plurality of metal plates by the etching. The nozzle plate 41 is formed, for example, of a polymeric synthetized resin material such as polyimide, etc., and is adhered to a lower surface of the stacked metal plates with an adhesive. A lower surface of the nozzle plate 41 becomes to be the above-described nozzle surface 11b. Note that it is allowable that the nozzle plate 41 is also formed of a metallic material such as stainless steel, etc.

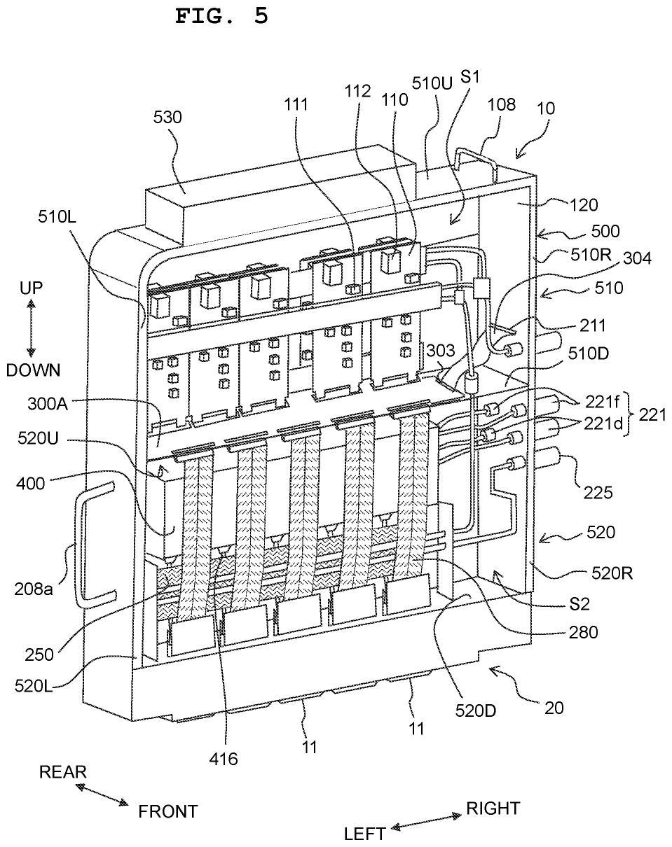

As depicted in FIG. 4, the individual channel 12 communicating with each of the nozzles 11a, and the supply manifold 13a and the return manifold 13b each communicating with the individual channel 12 are formed in the inside of the channel unit 42. Although not depicted in the drawings, the supply manifold 13a and the return manifold 13b extend along the left-right direction (in FIG. 4, a direction perpendicular to the sheet surface of the drawing). The supply manifold 13a is connected to a tank 400 (see FIG. 5) positioned at the outside of the head 11 via a non-illustrated ink supply port formed in the channel unit 42. The return manifold 13b is connected to the tank 400 positioned at the outside of the head 11 via a non-illustrated ink return port formed in the channel unit 42. This forms an ink circulation route in which the ink coming out of the tank 400 passes the supply manifold 13a, the individual channel 12 and the return manifold 13b and returns to the tank 400.

Note that although not depicted in the drawings, a plurality of individual channels 12, each of which corresponds to one of the plurality of nozzles 11a, are arranged so as to form two individual channel rows extending along the left-right direction, in correspondence to that the plurality of nozzles 11a are arranged so as to form the two nozzle rows extending along the left-right direction, as described above. Further, 12 of the supply manifolds 13a and 12 of the return manifolds 13b are formed in the channel unit 42; each of the 12 supply manifolds 13a and each of the 12 return manifold 13b communicate with individual channels 12, among the plurality of individual channels 12, constructing the two individual channel rows. With this, in the inside of the channel unit 42, a plurality of ink channels is formed, each of the plurality of ink channel starting from the supply manifold 13a, passing the pressure chamber 12a of one of the plurality of individual channels 12, and reaching one of the nozzles 11a and the return manifold 13b. Note that the number of the supply manifold 13a and the number of the return manifold 13b formed in the channel unit 42 are adjusted in accordance with the number of the nozzle 11a. Further, the number of the individual channel 12 communicating with each of the supply manifolds 13a and each of the return manifolds 13b is also adjusted in accordance with the number of the nozzle 11a.

As depicted in FIG. 4, the pressure chamber 12a is formed in each of the individual channels 12, and the actuator unit 40 is arranged at a location above a plurality of pressure chambers 12a each of which belongs to one of the plurality of individual channels 12. The actuator unit 40 is provided with a vibration plate 43 arranged on the upper surface of the channel unit 42 so as to cover all the pressure chambers 12a, a plurality of piezoelectric bodies 44 each of which is located on an upper surface of the vibration plate 43, at a position facing one of the pressure chambers 12a, and a plurality of individual electrodes 45 each of which is arranged on the upper surface of one of the plurality of piezoelectric bodies 44. As will be described later on, the vibration plate 43 functions as a common electrode. The vibration plate 43 as the common electrode, each of the individual electrodes 45, and each of the plurality of piezoelectric bodies 44 form one piece of a driving element 46. Namely, the actuator unit 40 includes a plurality of driving elements 46 each of which corresponds to one of the plurality of nozzles 11a.

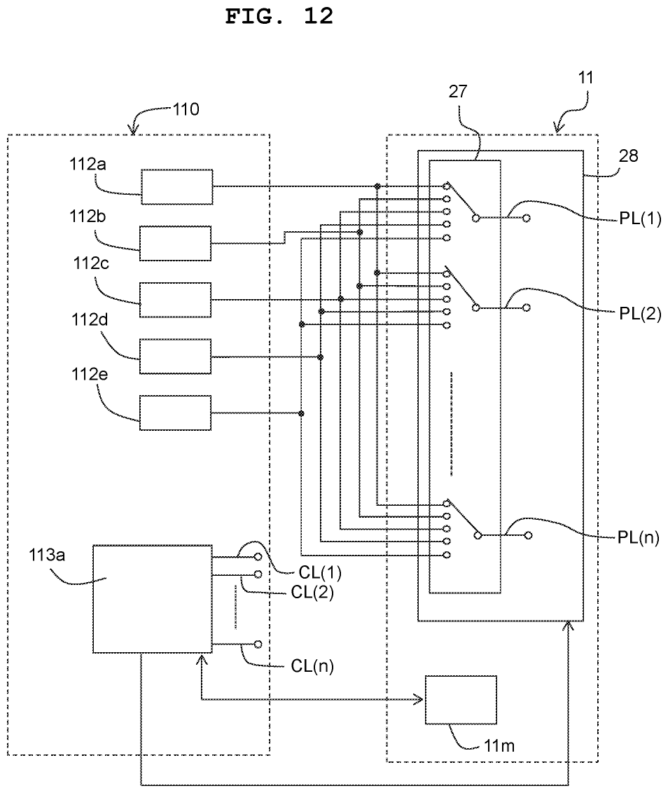

The vibration plate 43 is a metallic plate which has a substantially rectangular shape in a plan view, and is formed, for example, of an iron-based alloy such as stainless steel, a copper-based alloy, a nickel-based alloy, or a titanium-based alloy, etc. The upper surface of the vibration plate 43 having the electric conductivity is arranged at a location below the plurality of piezoelectric bodies 44. Accordingly, the upper surface of the vibration plate 43 is capable of functioning as the common electrode. The vibration plate 43 as the common electrode is connected to a ground wiring of a driver IC 28 (see FIG. 12) which drives the actuator unit 40, and is maintained to be the ground potential at all times. Note that it is not necessarily indispensable that the vibration plate 43 is the metallic plate; for example, it is allowable that the vibration plate 43 is formed of a piezoelectric material which is same as that forming the plurality of piezoelectric bodies 44, and that a metallic film as the common electrode is formed on the upper surface of the vibration plate 43.

Each of the plurality of piezoelectric bodies 44 is formed of a piezoelectric material composed primarily of lead zirconate titanate (PZT) which is a solid solution of lead titanate and lead zirconate and which is a ferroelectric substance. Each of the plurality of piezoelectric bodies 44 is polarized in a thickness direction (up-down direction) at least at an area facing the pressure chamber 12a (a part sandwiched between the individual electrode 45 and the vibration plate 43). In the present embodiment, although the plurality of piezoelectric bodies 44 are provided each corresponding to one of the pressure chambers 12a, the piezoelectric body 44 may be a layer of the piezoelectric body (piezoelectric layer) which is formed continuously across the plurality of pressure chambers 12a, on the upper surface of the vibration plate 43. In such a case, the vibration plate 43 as the common electrode, each of the plurality of individual electrodes 45 and a part, of the piezoelectric body 44, which is sandwiched between each of the plurality of individual electrode 45 and the vibration plate 43 form one piece of the driving element 46.

Next, an explanation will be given about an action of the driving element 46 of the actuator unit 40 at a time of ink discharge (ink ejection). In a case that a predetermined driving potential is applied from the driver IC 28 (see FIG. 12) to a certain individual electrode 45 included in the plurality of individual electrodes 45, a potential difference is generated between the certain individual electrode 45 to which the driving potential is applied and the vibration plate 43 as the common electrode and maintained at the ground potential. With this, an electric field in the thickness direction is generated at a certain piezoelectric body 44, of the plurality of piezoelectric bodies 44, which is sandwiched between the certain individual electrode 45 and the vibration plate 43. The direction of the electric filed is parallel to the polarization direction of the certain piezoelectric body 44. Accordingly, due to this electric field, an area (active area), of the certain piezoelectric body 44, which faces the certain individual electrode 45 contracts in a plane direction orthogonal to the thickness direction. Here, the vibration plate 43 which is on the lower side of the certain piezoelectric body 44 is fixed to the channel unit 42. Accordingly, accompanying with the active area, of the certain piezoelectric body 44, which is positioned on the upper surface of the vibration plate 43 contracting in the plane direction, a part of the vibration plate 43 which covers a certain pressure chambers 12a, among the plurality of pressure chambers 12a, corresponding to the certain individual electrode 45 is deformed so as to project toward the certain pressure chamber 12a (unimorph deformation, see FIG. 4). In this situation, since the volume inside the certain pressure chamber 12a is reduced, the pressure of the ink inside the certain pressure chamber 12a is increased, thereby discharging the ink from a nozzle 11a, among the nozzles 11a, communicating with the certain pressure chamber 12a.

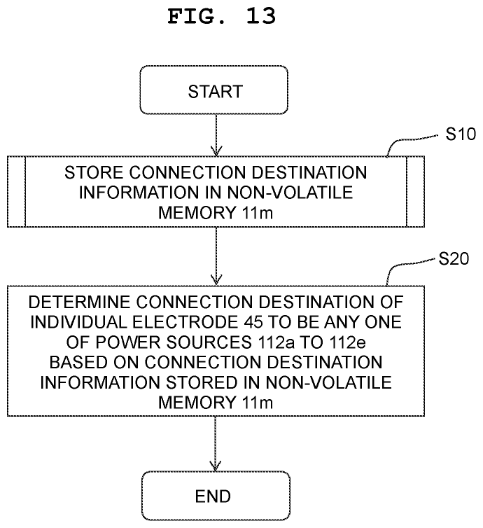

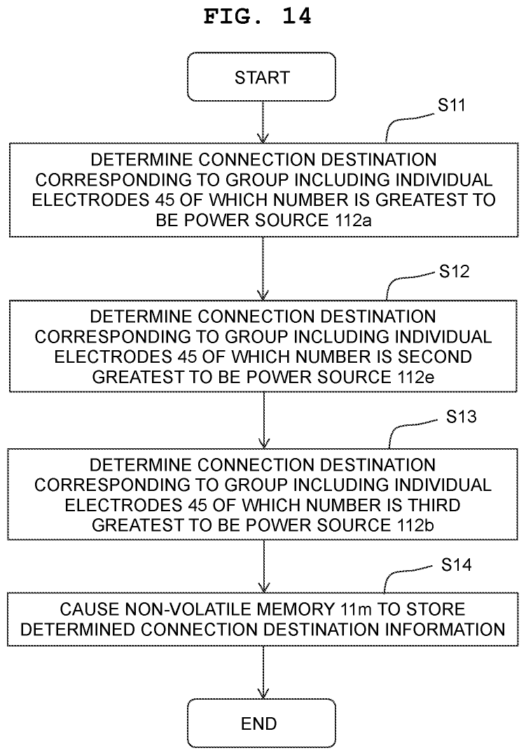

The controller 7 is provided with: an FPGA (Field Programmable Gate Array), an EEPROM (Electrically Erasable Programmable Read-Only Memory; EEPROM is a registered trade mark of Renesas Electronics Corporation), a RAM (Random Access Memory), etc. Note that the controller 7 may be provided with a CPU (Central Processing Unit) or an ASIC (Application Specific Integrated Circuit), etc. The controller 7 is connected to an external apparatus 9 (see FIG. 1) such as a PC to be capable of performing data communication therewith, and is configured to control the respective parts or components of the printing apparatus 1 based on print data transmitted from the external apparatus 9. The controller 7 is configured to execute a power source connecting processing (see FIGS. 13 and 14) which will be described later on.

The controller 7 controls the motor which drives the rotation shafts 4C and 4D and the motor which drives the conveying rollers 5A and 5B to thereby cause the two conveying rollers 5A and 5B to convey the recording medium 4 along the conveying direction. Further, the controller 7 controls the three head assemblies 10 so as to cause the inks to be discharged from the nozzles 11a toward the recording medium 4. With this, an image is recorded on the recording medium 4.

### [Configuration of Head Assembly 10]

Next, the configuration of the head assembly 10 will be explained, with reference to the drawings. Note that since the three head assemblies 10 has a same structure, the explanation will be made regarding one of the head assemblies 10. As described above, the three head assemblies 10 are arranged so as to be inclined with respect to the horizontal plane at the mutually different angles, respectively. However, in order to simplify the explanation, in the following description, the direction(s) is (are) defined on the premise that the head assemblies 10 are in a state of being perpendicular with respect to the horizontal plane. As depicted in FIG. 5, each of the head assemblies 10 is mainly provided with: a casing 500, a head group 20 including twelve heads 11, ten rigid substrates 110, twelve flexible substrates 280, a relay substrate 300, a tank 400, a heater 250, a plurality of tubes 416 connecting the heads 11 with the tank 400, and a cooler 600. Note that in FIG. 5, ten rigid substrates 110 among the twelve rigid substrates 110 are depicted and five flexible substrates 280 among the twelve flexible substrates 280 are depicted so as to simplify the drawing.

### [Casing 500]

As depicted in FIG. 5, the casing 500 has a substantially rectangular parallelepiped shape, and has a first frame part 510 defining a first space S1, a second frame part 520 defining a second space S2, and a lid 530 positioned above the first frame part 510. A grip 108 is provided on an upper surface 510U of the casing 500. Note that in FIG. 5, a front side wall and a rear side wall of each of the first frame part 510 and the second frame part 520 are removed so that the first space S1 and the second space S2 can be easily seen. Further, the illustration of a part of the configuration of the cooler 600 (a lever 640, a fixing part 630, etc., to be described later on) is also omitted. Note that the left-right direction corresponds to a depth direction of each of the first frame part 510 and the second frame part 520, and the front-rear direction corresponds to a width direction of each of the first frame part 510 and the second frame part 520. The left-right direction (which corresponds to the depth direction of each of the first frame part 510 and the second frame part 520) is orthogonal to both of the up-down direction and the front-rear direction (which corresponds to the width direction of each of the first frame part 510 and the second frame part 520).

As depicted in FIG. 5, the first frame part 510 is a frame member having a substantially rectangular parallelepiped shape. The first frame part 510 has a bottom surface 510D, a right side wall 510R and a left side wall 510L which extend upward, respectively, from both ends in the left-right direction of the bottom surface 510D, and the upper surface 510U. A non-illustrated opening is formed in the bottom surface 510D. Further, another opening (not depicted in the drawings) is formed in the upper surface 510U; the lid 530 is positioned in the upper surface 510U so as to close this opening. A power source input port 211 is positioned in the right side wall 510R.

The second frame part 520 is a frame member having a substantially rectangular parallelepiped shape. The second frame part 520 has a bottom surface 520D, a right side wall 520R and a left side wall 520L which extend upward, respectively, from both ends in the left-right direction of the bottom surface 520D, and an upper surface 520U. The right side wall 520R of the second frame part 520 is continuous with the right side wall 510R of the first frame part 510. The left side wall 520L of the second frame part 520 is continuous with the left side wall 510L of the first frame part 510. Four ink ports 221 and a cooling water port 225 are positioned in the right side wall 520R.

The cooling water port 225 is a port via which cooling water for cooling the heads 11 is supplied. The driving elements 46 inside each of the heads 11 and the driver IC 28 (see FIG. 12) which is configured to drive the driving elements 46 generate heat accompanying with the driving of the driving elements 46. Accordingly, in a case that each of the heads 11 is not sufficiently cooled, any unevenness in the temperature occurs in the head 11, due to which any difference in the viscosity occurs, in some cases, between a certain nozzle 11a and another nozzle 11a. In such a case, even in a case that a driving signal of a same waveform is inputted, there is such a fear that any difference in the size might arise between an ink droplet of the ink ejected from the certain nozzle 11a and an ink droplet of the ink ejected from the another nozzle 11a, in some cases, and which might lead to any lowering in the print quality. In view of this, in the present embodiment, the cooling water is introduced from the cooling water port 225 so as to cool the heads 11. A path or route of the cooling water introduced from the cooling water port 225 corresponds to an “IC cooling part” of the present disclosure. The cooling water which has cooled the heads 11 arranged in the second space S2 is sent to the first space S1 via a relay port 226 and is used as cooling water for cooling a water cooling block 610 which will be described later on. In this case, the cooling water for cooling the heads 11 and the cooling water for cooling the cooler 600 can be made common, thereby making it possible to simplify the configuration of a circulatory system of the cooling water.

A non-illustrated electric power cable from a non-illustrated external power source is connected to the electric power input port 211. The four ink ports 221 has two pairs each of which has an ink supply port 221f and an ink discharge port 221d connected, respectively, to a non-illustrated supply port and a non-illustrated discharge port belonging to the tank 400. Each of the two pairs of the ink supply port 221f and the ink discharge port 221d are connected to a same ink reservoir 8 (see FIGS. 1 and 2), and a same ink flows in each of the two pairs of the ink supply port 221f and the ink discharge port 221d. Note that it is not necessarily indispensable that the ink flowing in one of the two pairs of the ink supply port 221f and the ink discharge port 221 and the ink flowing in the other of the two pairs of the ink supply port 221f and the ink discharge port 221d are a same ink; the above-described inks may be, for example, inks of mutually different colors.

As depicted in FIG. 5, since the four ink ports 221 are arranged on the lower side of the power source input port 211, in a case that the ink leaks from the ink port(s) 211 and drips downward, there is no such a fear that the ink might adhere to the electric power input port 211. With this, it is possible to prevent any dirtying of the electric power input port 211 by the ink and any short circuit which would be otherwise caused by the adhesion of the ink to the electric power input port 211.

The upper surface 520U of the second frame part 520 and the bottom surface 510D of the first frame part 510 correspond, respectively, to an upper surface and a lower surface of a same plate member. Accordingly, the non-illustrated opening formed in the bottom surface 510D of the first frame part 510 as described above is opened also in the upper surface 520U of the second frame part 520. Further, the relay substrate 300 is positioned so as to close the non-illustrated opening in the upper surface 520U of the second frame part 520. With this, an upper surface of the relay substrate 300 defines a part of the first space S1, and a lower surface of the relay substrate 300 defines a part of the second space S2.

### [Relay Substrate 300]

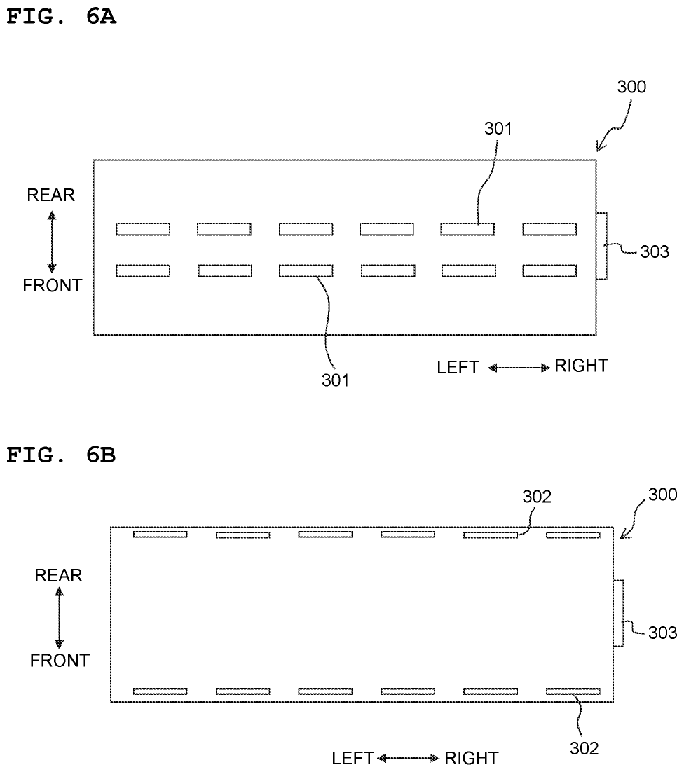

As depicted in FIGS. 6A and 6B, the relay substrate 300 is provided with 12 first connectors 301, 12 second connectors 302 and a power source connector 303. Each of the first connectors 301 corresponds to a “connector” of the present disclosure. The power source connector 303 is arranged at a right end of the relay substrate 300. As described above, the power source input port 211 is provided on the side wall 202R on the right side of the second casing 200. As depicted in FIG. 5, the power source connector 303 of the relay substrate 300 and the power source input port 211 are connected by a power source cable 304. Further, the twelve first connectors 301 are positioned in the upper surface, of the relay substrate 300, which is exposed in the first space S1 (see FIG. 6A). In other words, the twelve first connectors 301 are positioned in the upper surface, of the relay substrate 300, facing the first space S1. The twelve first connectors 301 are arranged in two rows along the front-rear direction (width direction). Each of the two rows of the first connectors 301 includes 6 of the first connectors 301 arranged in the left-right direction (depth direction). Namely, an extending direction (row direction) of the row of the first connectors 301 is parallel to the depth direction (left-right direction). As depicted in FIG. 6B, the twelve second connectors 302 are positioned in the lower surface, of the relay substrate 300, which is exposed in the second space S2. In other words, the twelve second connectors 302 are positioned in the lower surface, of the relay substrate 300, facing the second space S2. The twelve second connectors 302 are also arranged in two rows in the width direction (front-rear direction); and each of the two rows of the second connectors 302 includes 6 of the second connectors 302 arranged in the depth direction (left-right direction). Namely, an extending direction (row direction) of the row of the second connectors 302 is parallel to the depth direction (left-right direction). The left-right direction is an example of a “first direction” of the present disclosure, and the front-rear direction (width direction; conveying direction) is an example of a “second direction” of the present disclosure.

The relay substrate 300 is provided with a non-illustrated wiring connecting each of the 12 first connectors 301 to one of the 12 second connectors 302. With this, the second connectors 302 arranged on the lower surface of the relay substrate 300 and the first connectors 301 arranged on the upper surface of the relay substrate 300 are electrically connected. Further, the relay substrate 300 has a non-illustrated electrical source wiring connecting the power source connector 303 and the twelve first connectors 301 and a non-illustrated electrical source wiring connecting the power source connector 303 and the twelve second connectors 302. With this, the relay substrate 300 is capable of supplying the electric power from the non-illustrated external power source to a device, etc., connected to each of the first connectors 301 and the second connectors 302. Note that the non-illustrate external power source is different from a power source 112, of the rigid substrate 110, which will be described later on.

### [First Space S1]

Next, an explanation will be given about a member positioned in the first space S1, with reference to the drawings.

### [Rigid Substrate 110]

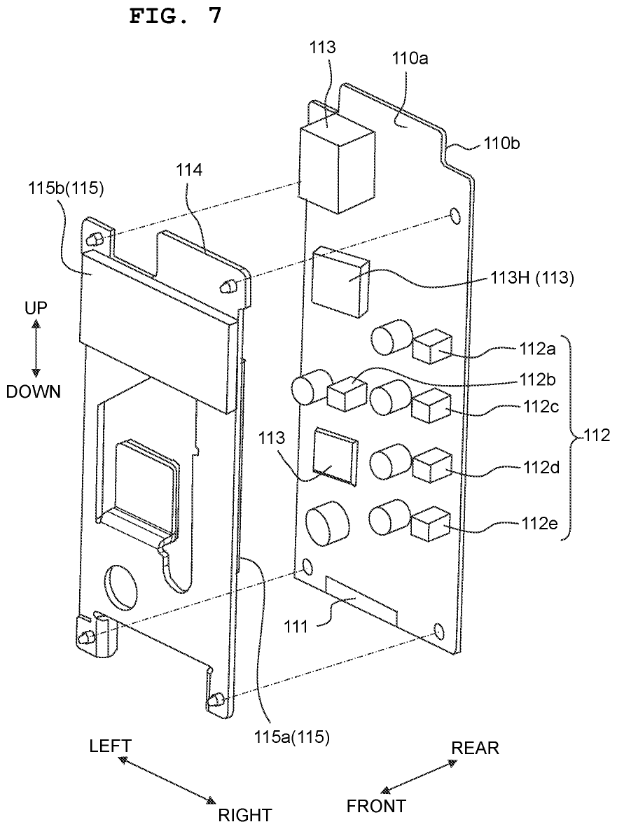

As depicted in FIG. 5, twelve rigid substrates 110 are arranged in the first space S1. As depicted in FIG. 7, each of the rigid substrates 110 is a substantially rectangular substrate and is a head controlling substrate configured to drive and control the head 11. The rigid substrate 110 corresponds to a “substrate” of the present disclosure. Each of the rigid substrates 110 has a substrate connector 111, five power sources 112a to 112e, a plurality of circuit elements 113, a heat spreader 114 and a thermal conducting sheet 115 (thermal conducting sheets 115a and 115b). The five power sources 112a to 112e and a part of the plurality of circuit elements 113 are mounted on a first surface 110a of the rigid substrate 110. Note that in the following explanation, in a case that the power sources 112a to 112e are not particularly distinguished, these power sources 112a to 112e are summarily referred to simply as a power source 112, in some cases. Although not depicted in FIG. 7, the power source 112 is not mounted in a second surface 110b (see FIG. 7) which is a rear surface with respect to the front surface 110a; rather, a part of the plurality of circuit elements 113 (for example, a circuit configured to process a high speed signal) is mounted on the second surface 110b. Note that all of the plurality of circuit elements 113 are not of a same kind, and the plurality of circuit elements 113 includes a plurality of kinds of circuit element.

A height of the power source 112 mounted on the first surface 110a of the rigid substrate 110 is higher than a height of the part of the plurality of circuit elements 113 mounted on the second surface 110b as the rear surface of the rigid substrate 110. Note that the term “height” herein represents a height from the first surface 110a (or the second surface 110b) in the normal direction perpendicular to the rigid substrate 110 (in FIG. 5, the normal direction is parallel to the front-rear direction).

The power sources 112a to 112e are mounted on the first surface 110a of each of the rigid substrates 110, to be dispersed in the up-down direction. The phrase that “the power sources 112a to 112e are dispersed in the up-down direction” means that a position in the up-down direction of at least one of the five power sources 112a to 112e is different from the position in the up-down direction of the remaining power sources. In the present embodiment, as depicted in FIG. 7, the power source 112a is positioned at an uppermost location, and each of the power sources 112b and 112c is positioned at a location below the power source 112a. The positions in the up-down direction of the power sources 112b and 112c are substantially same. The power source 112d is positioned at a location below the power sources 112b and 112c, and the power source 112e is positioned at a location below the power source 112d.

The heat spreader 114 is overlaid on the first surface 11a of the rigid substrate 110. The heat spreader 114 is formed of a plate made of a metal such as aluminum. A surface, of the heat spreader 114, facing the first surface 110a of the rigid substrate 110 thermally makes contact with the power sources 112a to 112e via the thermal conducting sheet 115a. The thermal conducting sheet 115a is positioned between the heat spreader 114 and the power sources 112a to 112e. The thermal conducting sheet 115a has a flexibility; thus, even in such a case that a difference in height to some extent is present among the power sources 112a to 112e due to any variation in an amount of solder at a time of mounting the power sources 112a to 112e, it is possible to absorb such a difference in the height by the thermal conducting sheet 115a. Namely, also in such a case that the difference in height to some extent is present among the power sources 112a to 112e, it is possible to make the thermal conducting sheet 115a and the power sources 112a to 112e to contact with one another in an ensured manner. This makes it possible to make the heat spreader 114 and the power sources 112a to 112b to thermally contact with one another in an ensured manner.

Further, a thermal conducting sheet 115b is positioned on a surface, of the heat spreader 114, on a side opposite to the rigid substrate 110 at a position overlapping with the power source 112a and a circuit element 113H in the front-rear direction. As will be described later on, among the five power sources 112a to 112e, the power source 112a is a power sources having individual electrodes 45 of which number (quantity) is greatest among the plurality of individual electrodes 45 connected thereto. Accordingly, the heating value of the power source 112a is greatest among the five power sources 112a to 112e. Furthermore, since the circuit element 113H is one of the plurality of circuit elements 113, and the heating value of the circuit element 113H is greatest among the plurality of circuit elements 113 and the five power sources 112a to 112e which are mounted on the rigid substrate 110.

In the present embodiment, a water cooling block 610 makes contact with the thermal conducting sheet 115b, as will be described later on. With this, it is possible to make the power source 112a, of which heating value is the greatest among the five power sources 112a to 112e, and the circuit element 113 of which heating value is the greatest among the plurality of heating elements 113 and the five power sources 112a to 112e mounted on the rigid substrate 110, to thermally contact with the water cooling block 610 in the ensured manner.

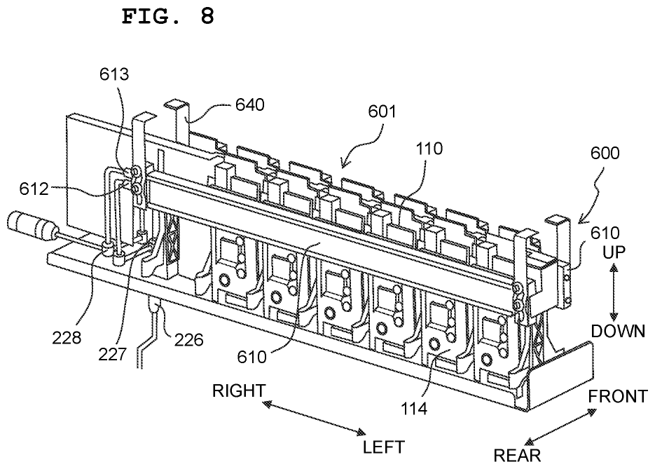

The substrate connector 111 is positioned at a lower end of the rigid substrate 110, and is configured to be insertable and detachable with respect to each of the 12 first connectors 301 of the relay substrate 300. The inserting/detaching direction of the rigid substrate 110 corresponds to the up-down direction. With this, in a state that the rigid substrate 110 is inserted into the first connectors 301, the rigid substrate 110 is fixed so as to stand perpendicularly with respect to the relay substrate 300 (see FIG. 8). As described above, since the first connectors 301 are arranged in the two rows, the rigid substrates 110 are also arranged in two rows. As depicted in FIG. 8, the rigid substrates 110 in one and the other of the two rows are aligned in the two rows back to back with respect to one another so that the first surfaces 110a of the respective rigid substrates 110 each of which has the power source 112 mounted thereon do not face in the width direction (front-right direction).

### [Cooler 600]

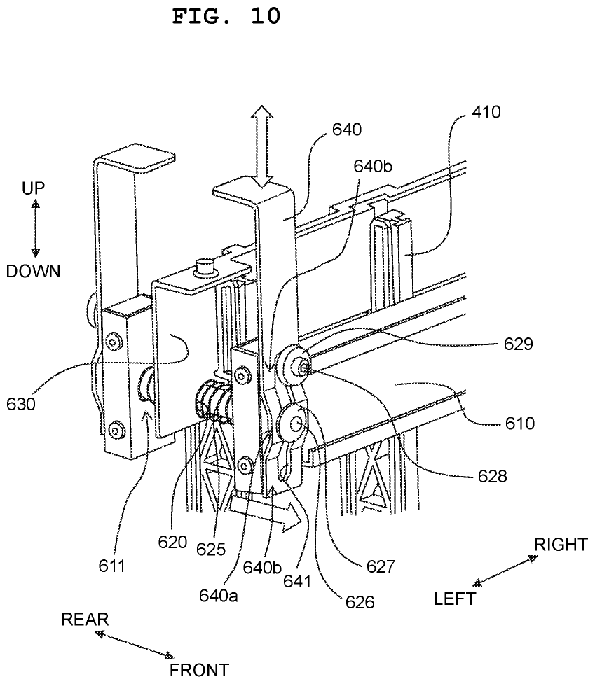

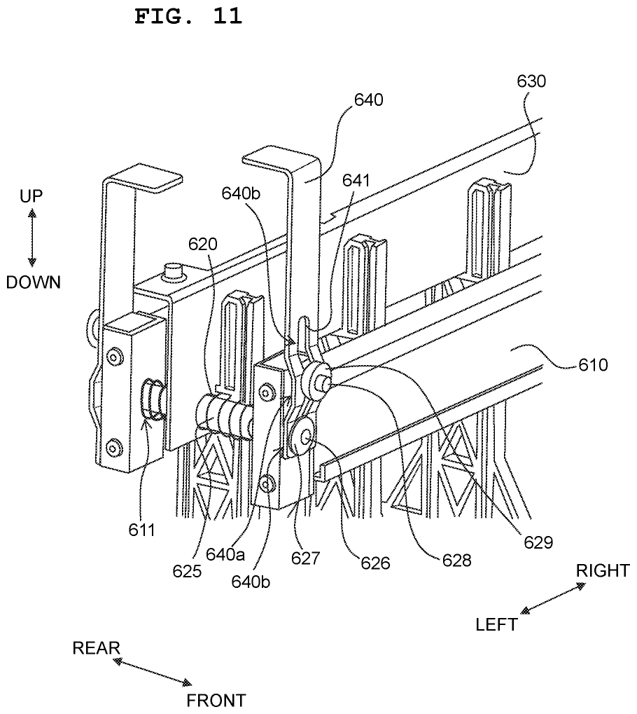

As depicted in FIGS. 8, 9 and 10, the cooler 600 is mainly provided with: a water cooling part 601 having two water cooling blocks 610; four springs 620 configured to urge the two water cooling blocks 610 of the water cooling part 601 in the front-rear direction (each of which is an example of an “urging member” of the present disclosure); two shafts 625; a fixing part 630 configured to fix an end of each of the two shafts 625; and four levers 640 (see FIGS. 10 and 11). The fixing part 630 is a plate-shaped member extending along the left-right direction between the rigid substrates 110 aligned in the two rows, and is fixed with respect to a supporting part 410 (see FIGS. 10 and 11) configured to support the rigid substrates 110.

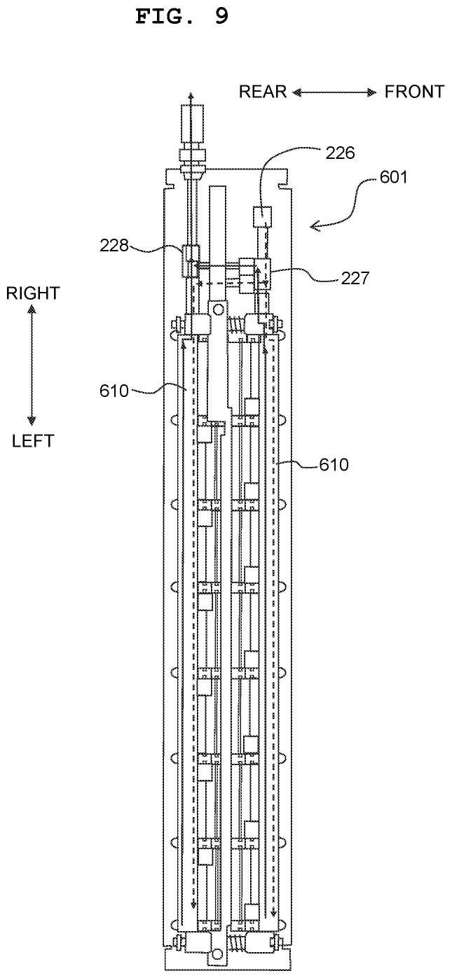

As depicted in FIG. 8, the water cooling block 610 is a member having a substantially rectangular parallelepiped shape which extends along the left-right direction and in substantially parallel to the fixing part 630; the water cooling block 610 is provided with an inlet port 612 and an outlet port 613 of the cooling water. A cooling water channel (see FIG. 9) which is substantially U-shaped, which extends along the left-right direction from the outlet port 612, which makes U-turn at an end part in the left-right direction of the water cooling block 610 and which returns up to the outlet port 613 is formed in the inside of the water cooling block 610. Through holes 611 configured to allow the shaft 625 to be inserted therethrough are formed each at one of the end parts in the left-right direction of the water cooling block 610 (see FIGS. 10 and 11).

As depicted in FIG. 8, the cooling water which has cooled the heads 11 passes the relay port 226 and then is branched at a branching part 227 and is introduced to the inlet port 612 of each of the two water cooling blocks 610. After the cooling water has passed the cooling water channel in the inside of each of the two water cooling blocks 610, the cooling water coming out of the outlet port 613 of one of the two water cooling blocks 610 and the cooling water coming out of the outlet port 613 of the other of the two water cooling blocks 610 join at a joining part 228.

Next, an explanation will be given about the shape of the two shafts 625, with reference to FIGS. 10 and 11. One shaft 625 of the two shafts 625 is fixed to a left end of the fixing part 630. The one shaft 625 of the two shafts 625 extends rearward from a rear surface of the left end of the fixing part 630, along the front-rear direction and extends frontward from a front surface of the left end of the fixing part 630, along the front-rear direction. Namely, the one shaft 625 of the two shafts 625 penetrates through the fixing part 630 and extends toward the both sides of the front-rear direction. A substantially central part in the front-rear direction of each of the two shafts 625 is fixed to the fixing part 630. Although not depicted in the drawings, one shaft 625 (the other shaft 625) of the two shafts 625 is fixed also to a right end of the fixing part 630. Each of the two shafts 625 is inserted into a through hole 611 formed in one of ends in the left-right direction of the water cooling block 610, and a forward end of the shaft 625 (an end part, of the shaft 625, on a side opposite to the fixing part 630) passes the through hole 611 and extends further along the front-rear direction, and makes contract with a lever 640 of the four levers 640. A part, of the lever 640, which makes contact with the shaft 625 is formed with a slit 641 extending along the up-down direction. Since the diameter of the shaft 625 is greater than a width of the slit 641 of the lever 640, the forward end of the shaft 625 is not capable of passing the slit 641 and is not capable of projecting (protruding) in the front-rear direction, and thus the forward end of the shaft 625 makes contact with the lever 640, as described above. A positioning pin 626, which projects in a direction away from the fixing part 630 in the front-rear direction is positioned in the forward end of the shaft 625. The diameter of the positioning pin 626 is smaller than the width of the slit 641 of the lever 640, and the forward end of the positioning pin 626 passes the slit 641 of the lever 640, and projects in the front-rear direction. Further, a stopping (retaining) washer 627 is positioned at the forward end of the positioning pin 626. The diameter of the washer 627 is greater than the width of the slit 641 of the lever 640, which in turn prevents the positioning pin 626 from detaching or being removed from the slit 641 of the lever 640. With this, in a state that the positioning pin 626 is inserted into the slit 641 of the lever 640, the lever 640 is sandwiched between the forward end of the shaft 625 and the washer 627 in the front-rear direction.

Each of the two shafts 625 is positioned within the inner diameters of two springs 620, of the four springs 620, each of which is a coil spring. An end of each of the two springs 620 makes contact with the fixing part 630 and the other end of each of the two springs 620 makes contact with a surface, of one of the two water cooling blocks 610, facing the fixing part 630. Each of the two springs 620 urges, in the front-rear direction, one of the two water cooling blocks 610 in a direction separating away from the fixing part 630.

A guide pin 628 which projects in an orientation separating away from the fixing part 630 in the front-rear direction is made to stand at a location above the through hole 611 of the water cooling block 610. The guide pin 628 is also inserted into the slit 641 formed in the lever 640, and a forward end of the guide pin 628 protrudes from the slit 641 of the lever 640 in the front-rear direction. In a similar manner regarding the forward end of the positioning pin 626, a stopping (retaining) washer 629 is also positioned at a forward end of the guide pin 628, thereby preventing the guide pin 628 from being removed or detached from the slit 641 of the lever 640. With this, in a state that the guide pin 628 is inserted into the slit 641 of the lever 640, the lever 640 is sandwiched between the washer 627 and a surface, of the water cooling block 610, on a side opposite to the fixing part 630 in the front-rear direction.

As depicted in FIGS. 10 and 11, each of the four levers 640 is a member which has a shape of letter “L” and which is long in the up-down direction. In the front-rear direction, each of the four levers 640 is positioned on a side opposite to the fixing part 630 of the water cooling block 610. An upper part of each of the levers 640 is an operating part which is gripped or held and is operated by a user; the upper part extends in the up-down direction and then extends along a direction approaching close to the fixing part 630 along the front-rear direction. The slit 641 extending along the up-down direction is formed at a lower part of the lever 640. A part, of the lever 640, in which the slit 641 is formed is provided with a first part 640a and second parts 640b which are different from the first part 640a. The first part 640a is separated from the surface, of the water cooling block 610, which is on the side opposite to the fixing part 630, in the front-rear direction. The second parts 640b are positioned, respectively, at the both ends in the up-down direction of the first part 640a, and make contact with the surface, of the water cooling block 610, which is on the side opposite to the fixing part 630.

As depicted in FIG. 10, in a case that the first part 640a of the lever 640 and the positioning pin 626 are located, respectively, at positions overlapping with each other and that the second part 640b of the lever 640 and the guide pin 628 are located, respectively, at positions overlapping with each other, the water cooling block 610 approaches the closest with respect to the fixing part 630 in the front-rear direction. In this situation, the water cooling block 610 makes contact with the thermal conducting sheet 115b (see FIG. 7) adhered to the heat spreader 114. With this, it is possible to cause the water cooling block 610 to be pressed to and to and make contact with the thermal conducting sheet 115b in an ensured manner, thereby making it possible to cool, with the water cooling block 610, the power source 112a and the circuit element 113H which are positioned to be overlapped in the front-rear direction with the thermal conducting sheet 115b. In contrast with this, as depicted in FIG. 11, in a case that the first part 640a of the lever 640 and the positioning pin 626 are located, respectively, at positions overlapping with each other and that the second part 640b of the lever 640 and the guide pin 628 are located, respectively, at positions overlapping with each other, the water cooling block 610 is urged by the spring 620 and thus is separated the farthest with respect to the fixing part 630 in the front-rear direction. In this situation, the water cooling block 610 is separated away from the thermal conducting sheet 115b adhered to the heat spreader 114. In a case, for example, that the power source 112 mounted on the rigid substrate 110 is broken, etc., the rigid substrate 110 is exchanged, in some cases. Since it is possible to separate the water cooling block 610 from the thermal conducting sheet 115b adhered to the heat spreader 114, it is possible to easily remove or pull out the rigid substrate 110 in a case of exchanging the rigid substrate 110. In such a manner, the user is capable of moving the water cooling block 610 easily along the front-rear direction only by sliding the lever 640 along the up-down direction. The up-down direction is an example of a “separating direction” of the present disclosure.

### [Second Space S2]

Next, members arranged in the second space S2 will be explained. As depicted in FIG. 5, the lower surface of the relay substrate 300 is exposed in the second space S2. Further, the head group 20 including the twelve heads 11, the twelve flexible substrates 280, the tank 400, the heater 250, and the plurality of tubes 416 connecting the twelve heads 11 and the tank 400 are positioned in the second space S2. Note that as described above, in FIG. 5, the number of each of the head 11, the tube 416 and the flexible substrate 280 is reduced so as to simplify the drawing.

### [Flexible Substrate 280]

One end of each of the flexible substrates 280 is connected to one of the second connectors 302 of the relay substrate 300. Further, the other end of each of the flexible substrates 280 is connected to one of the heads 11. Note that, as described above, the second connectors 302 of the relay substrate 300 are electrically connected to the first connectors 301 arranged on the upper surface of the relay substrate 300, and further that the first connectors 301 are electrically connected to the substrate connectors 111 of the rigid substrates 110. Namely, each of the rigid substrates 110, which is a head controlling substrate configured to drive and control one of the heads 11, is connected to one of the heads 11 via the relay substrate 300 and one of the flexible substrates 280. With this, each of the rigid substrates 110 is capable of transmitting a control signal with respect to one of the heads 11, such as the driving signal with respect to the piezoelectric element 46 of the actuator unit 40 of one of the heads 11, via the relay substrate 300 and one of the flexible substrates 280.

### [Tank 400]

As depicted in FIG. 5, the tank 400 is arranged in the second space S2 at a location below the relay substrate 300. The tank 400 has a shape of a substantially rectangular parallelepiped which is long in the left-right direction. The tank 400 is connected to each of the twelve heads 11 via one of the plurality of tubes 416. In order to simplify the drawing, the number of the tube 416 connected to the tank 400 is reduced in the illustration of FIG. 5.

### [Heater 250]

In the present embodiment, since the UV-curable ink is used, it is necessary to maintain the temperature of the ink at a predetermined temperature. Accordingly, the head assemblies 10 in the present embodiment are provided with the heater 250 configured to warm or heat the ink in the inside of each of the tubes 416 connecting the tank 400 and one of the heads 11. As depicted in FIG. 5, the heater 250 is provided at a position overlapping with the tubes 416 in the front-rear direction. As the heater 250, it is allowable to use, for example, a carbon heater which generates heat by supplying an electric current to a carbon sheet. Note that in order to warm the ink inside the tank 400 in advance, it is also possible to provide, for example, a sheet-shaped heater in the lower surface of the tank 400.

Next, a connection between the power sources 112a to 112e and the individual electrode 45 of each of the driving elements 46 will be explained. As depicted in FIG. 12, the power sources 112a to 112e are connected, via a switching element 27 included in the driver IC 28 provided on the head 11, to a first power source line PL(1) to a n-th power source line PL(n) (n is an integer of not less than 2 (two)). An FPGA 113a outputs, with respect to the switching circuit 27, a signal for causing each of the first power source line PL(1) to the n-th power source line PL(n) to be connected to any one of the power sources 112a to 112e. The switching circuit 27 causes each of the first power source line PL(1) to the n-th power source line PL(n) to be connected to any one of the power sources 112a to 112e, based on the signal from the FPGA 113a.

Although not depicted in the drawings, the first power source line PL(1) to the n-th power source line PL(n) of the switching circuit 27 are connected to a non-illustrated CMOS circuit (specifically, a source terminal of a PMOS transistor of the CMOS circuit). The driver IC 28 includes the CMOS circuit and the CMOS circuit is connected to the individual electrode 45 of each of the driving elements 46. Further, the FPGA 113a outputs, with respect to the CMOS circuit, a gate signal via a first control line CL(1) to a n-th control line CL(n) (n is an integer not less than 2 (two)). With this, an output voltage signal of any one of the power sources 112a to 112e is outputted, based on the gate signal from the FPGA 113a and via the CMOS circuit, to the individual electrode 45 of each of the driving elements 46.

In the present embodiment, the plurality of driving elements 46 of which number corresponds to the number of the nozzles 11a, namely, the plurality of individual electrodes 45 of which number corresponds to the number of the nozzles 11a, is included in the head 11, as described above. Further, the output voltage signal of any one of the power sources 112a to 112e is supplied to each of the plurality of individual electrodes 45, via the CMOS circuit, as described above. Information regarding which one of the five power sources 112a to 112e is a connection destination of each of the plurality of individual electrodes 45 (hereinafter referred to as “connection destination information”) is stored in a non-volatile memory 11m of the head 11 (an example of “memory” of the present disclosure). The FPGA 113a controls the switching circuit 27 based on the connection destination information stored in the non-volatile memory 11m, so as to set the connection destination of each of the plurality of individual electrodes 45 to be any one of the power sources 112a to 112e.

The plurality of individual electrodes 45 can be divided into five groups in accordance with each of the plurality of individual electrodes 45 is to be connected to which one of the five power sources 112a to 112e. In the present embodiment, a number of the individual electrode 45 included in each of the five groups is not all the same among the five groups. In the present embodiment, in a case of storing the connection destination information in the non-volatile memory 11m, a connection destination corresponding to a group including individual electrodes 45, of the plurality of individual electrodes 45, of which number is greatest among the five groups is made to be the power source 112a. Further, a connection destination corresponding to a group including individual electrodes 45, of the plurality of individual electrodes 45, of which number is second greatest among the five groups is made to be the power source 112e. Furthermore, a connection destination corresponding to a group including individual electrodes 45, of the plurality of individual electrodes 45, of which number is third greatest among the five groups is made to be the power source 112b. Note that as described above, in the first surface 110a of the rigid substrate 110, the power source 112a is positioned at the uppermost location among the five power sources 112a to 112e, and the power source 112e is positioned at a location below the power source 112d. Further, the power source 112b is positioned at a location between the power source 112a and the power source 112e.

Next, the power source connecting processing executed by the controller 7 will be explained with reference to FIGS. 13 and 14.

As depicted in FIG. 13, the controller 7 determines the power source which is to be the connection destination of each of the plurality of driving elements 46 to be any one of the power sources 112a and 112e, based on a corresponding relationship between the five groups and the individual electrodes 45 (driving elements 46) which is stored in the non-volatile memory 11m, and the controller 7 causes the non-volatile memory 11m to store the connection destination information determined thereby (step S10).

Specifically, as depicted in FIG. 14, the controller 7 determines the connection destination of the individual electrodes 45 included in the group in which the number of the individual electrodes 45 included therein is the greatest among the five groups to be the power source 112a which is positioned at the uppermost location in the rigid substrate 110 (step S11). Next, the controller 7 determines the connection destination of the individual electrodes 45 included in the group in which the number of the individual electrodes 45 included therein is the second greatest among the five groups to be the power source 112e which is positioned at the lowermost location in the rigid substrate 110 (step S12). Note that the orders of step S11 and step S12 may be reversed. Namely, it is allowable to execute step S12 first, and then to execute step S11. Further, the controller 7 determines the connection destination of the individual electrodes 45 included in the group in which the number of the individual electrodes 45 included therein is the third greatest among the five groups to be the power source 112b which is positioned at a location between the power source 112a which is positioned at the uppermost location and the power source 112e which is positioned at the lowermost location in the rigid substrate 110 (step S13). Then, the controller 7 causes the non-volatile memory 11m to store the determined connection destination information (step S14).

The controller 7 causes the FPGA 113a to read the connection destination information stored in the non-volatile memory 11m, and further controls the FPGA 113a so that the FPGA 113a causes each of the plurality of individual electrodes 45 to be connected to any one of the power sources 112a to 112e, based on the connection destination information which has been read (step S20).

### [Action and Effect of Present Embodiment]

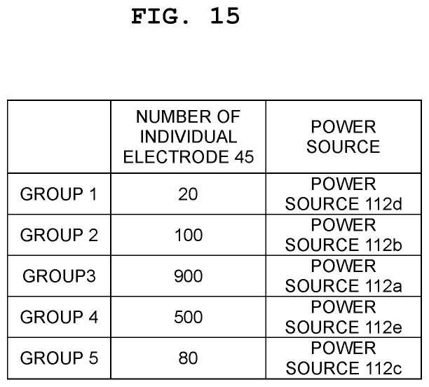

In the present embodiment, the head assembly 10 has at least one head 11, at least one rigid substrate 110 (an example of a “substrate” of the present disclosure) electrically connected to the at least one head 11, and the cooler 600. Each of the at least one head 11 is provided with the plurality of driving elements 46, and each of the plurality of driving elements 46 is provided with one of the plurality of individual electrodes 45. The plurality of power sources 112a to 112e is mounted on each of the at least one rigid substrate 110, and each of the power sources 112a to 112e is connected to the plurality of driving elements 45 of the head, of the at least one head 11, corresponding thereto. Further, the plurality of power sources 112a to 112e are positioned so that at least one power source, of the plurality of power sources 112a to 112e is/are dispersed in the up-down direction. Furthermore, the cooler 600 cools the power source 112a which is positioned at the uppermost location among the plurality of power sources 112a to 112e mounted on the rigid substrate 600. In the above-described embodiment, the non-volatile memory 11m provided on the head assembly 10 stores the information of the connection destination indicated as to each of the plurality of individual electrodes 45 is to be connected to which one of the power sources 112a to 112e. As an example of the information of the connection destination stored in the non-volatile memory 11m, FIG. 15 indicates a correspondence table, in a case that the plurality of individual electrodes 45 are divided into the five groups (group 1 to group 5) each corresponding to the connection destination thereof, between the numbers (quantities) of the individual electrodes 45 included in the respective five groups and the power sources 112 each of which corresponds, as the connection destination thereof, to one of the five groups. Note that FIG. 15 indicates a case that the number of the plurality of individual electrodes 45 is 1600. As indicated in FIG. 15, in the present embodiment, in the case that the plurality of individual electrodes 45 are divided into the five groups corresponding to the connection destinations thereof, the connection destination corresponding to the group 3 including the individual electrodes 45 of which number is the greatest is made to be the power source 112a. Note that the power source 112a is the power source which is positioned at the uppermost location in the up-down direction among the power sources 112a to 112e, and which is the power source cooled by the cooler 600.

The heating value of the power source which is included in the plurality of power sources 112a to 112e mounted on the rigid substrate 110 and connected to the individual electrodes 45 which are included in the plurality of individual electrodes 45 and of which number (quantity) is greatest among the plurality of individual electrodes 45 becomes to be greatest among the plurality of power sources 112a to 112e. In the above-described configuration, the power source 112a connected to the individual electrodes 45 of which number (quantity) is greatest among the plurality of individual electrodes 45 is the power source (112a) which is positioned at the uppermost location among the power sources 112a to 112e. In this case, since the convected heat is oriented upward, it is possible to suppress the occurrence of such a situation that the convected heat generated from the power source 112a of which heating value becomes to be greatest affects other power sources 112b to 112e. Further, since the cooler 600 is configured to cool the power source 112a which is positioned at the uppermost location, it is possible to effectively cool the power source 112a of which heating value becomes to be greatest. With this, it is possible to suppress any degradation or deterioration of the power source 112a of which heating value becomes to be greatest, and to suppress any variation in the length of the service life among the plurality of power sources 112a to 112e.

In the present embodiment, in a case that the plurality of individual electrodes 45 is divided into the five groups 1 to 5 corresponding to the connection destinations thereof, the connection destination corresponding to the group 4 including individual electrodes 45, of the plurality of individual electrodes, of which number is second greatest among the five groups is made to be the power source 112e (see FIG. 15). Note that the power source 112e is the power source which is positioned at the lowermost location among the five power sources 112a to 112e. As described above, it is known that the service life of a power source is affected by the output current and the environmental temperature. With respect to the power source 112e, the number of the individual electrodes 45, of the plurality of individual electrodes 45, which are connected to the power source 112e is greatest among the power sources 112a to 112e, except for the power source 112a as the connection destination of the group 3 including the individual electrodes 45 of which number is the greatest among the power sources 112a to 112e. Accordingly, among the four power sources 112b to 112e excluding the power source 112a, the load of the output electric current becomes greatest in the power source 112e; accompanying with this, the heating value of the power source 112e becomes the greatest among the four power sources 112b to 112e. As described above, since the convected heat is oriented upward, provided that the power source 112e is positioned above the power sources 112b to 112d, the power source 112e is consequently affected by the convected heat from the power sources 112b to 112d which are positioned below the power source 112e. In such a case, in addition to the load of the output electric current, of the power source 112e, which is greater than the load of the output current of each of the power sources 112b to 112d, the power source 112e is affected by the convected heats from the other power sources 112b to 112d. Due to this, it is considered that the service life of the power source 112e becomes short. From such a view point, the connection destination corresponding to the group 4 including the individual electrodes 45 of which number is the second greatest is preferably made to be the power source 112e which is positioned at the lowermost location among the power sources 112a to 112e.

In the present embodiment, in the case that the plurality of individual electrodes 45 is divided into the five groups 1 to 5 corresponding to the connection destinations thereof, the connection destination corresponding to the group 2 including individual electrodes 45, of the plurality of individual electrodes 45, of which number is third greatest among the five groups is made to be the power source 112b, the connection destination corresponding to the group 5 including individual electrodes 45, of the plurality of individual electrodes 45, of which number is fourth greatest among the five groups is made to be the power source 112c, and the connection destination corresponding to the group 1 including individual electrodes 45, of the plurality of individual electrodes 45, of which number is fifth greatest among the five groups is made to be the power source 112d (see FIG. 15). Note that each of the power sources 112b to 112d is positioned between the power source 112a and the power source 112e in the up-down direction. The power sources 112b to 112d which correspond, respectively, to the groups 2, 5 and 1 are affected by the convected heat from the power source 112e which is positioned therebelow. This might be a factor in shortening the service life of each of the power sources 112b to 112d. However, since the power sources 112b to 112d are the power sources corresponding, respectively, to the groups 2, 5 and 1 including the individual electrodes 45 of which numbers are third, fourth and fifth greatest, respectively, and thus the load due to the output electric current in each of the power sources 112b to 112d is relatively small. This may be a factor in prolonging the service life of each of the power sources 112b to 112d. In a case of considering these two factors, it is possible to suppress any variation in the length of the service life among the plurality of power sources 112a to 112e.

In the above-described embodiment, the circuit element 113H (an example of a “heating member” of the present disclosure) of which heating value is greater than the heating values of the power sources 112a to 112e is mounted on the rigid substrate 110. The water cooling block 610 of the cooler 600 is configured to cool both of the power source 112a and the circuit element 113H. In this case, since is it possible to effectively cool the circuit element 113H of which heating value is greater than the heating values of the power sources 112a to 112e, it is possible to suppress such a situation that the radian heat and/or the convected heat from the circuit element 113H affect(s) another power source(s) and/or another circuit element(s). Further, in the above-described embodiment, the water cooling block 610 of the cooler 600 is capable of commonly cool both of the power source 112a and the circuit element 113H with one piece of the water cooling block 610. With this, since the circuit element 113H of which heating value is greater than the heating values of the another circuit element(s) and the heating values of the other power sources and the power source 112a of which heating value is greater than the heating values of the other power sources can be cooled with one piece of the water cooling block 610, the configuration of the cooler 600 can be simplified.

In a case of considering only the suppression of the variation in the length of the service life among the power sources 112a to 112e, it is considered to directly cool the power sources 112a to 112e with the water cooling block 610. In such a case, it is required to position the water cooling block 610 of the cooler 600 so that the water cooling block 610 overlaps with the power sources 112a to 112e in the front-rear direction. In such a case that the water cooling block 610 of the cooler 600 is configured to directly cool the power sources 112a to 112e, the size of the water cooling block 610 inevitably becomes large. Further, accompanying with this, the size of the heat spreader 114 also becomes large. Such an increase in the size of each of the water cooling block 610 and the heat spreader 114 becomes more prominent as the number of the rigid substrate 110 is greater. In contrast, in the present embodiment, although the water cooling block 610 of the cooler 600 overlaps with the power source 112a in the front-rear direction, the water cooling block 610 does not overlap with the power source 112b to 112e. With this, it is possible to suppress any excessive increase in the size of each of the water cooling block 610 and the heat spreader 114, and to effectively cool, with the water cooling block 610, the power source 112a of which heating value is greater than the heating values of the other power sources 112b to 112e. With this, it is possible to suppress the occurrence of such a situation that the service life of the power source 112a becomes short and to suppress any variation in the length of the service life among the plurality of power sources 112a to 112e.

In the present embodiment, the circuit element 113H is positioned above the power source 112a. With this, it is possible to suppress the occurrence of such a situation that the convected heat from the circuit element 113H of which heating value is greater than the heating value of the power source 112a affects the other power sources(s) and/or other circuit element(s). Note that the circuit element 113H may be a power source configured to supply a voltage to the vibration plate 43 as the common electrode.

The plurality of rigid substrates 110 are arranged side by side in a row along the left-right direction (an example of a “first direction” of the present disclosure), and the cooler 600 is provided with the water cooling part 601 extending along the left-right direction. Further, the plurality of rigid substrates 110 is arranged to form the two rows along the front-rear direction (an example of a “second direction” of the present disclosure) which is orthogonal to the left-right direction. Furthermore, the water cooling part 601 of the cooler 600 is provided with the two water cooling blocks 610 which are arranged side by side along the front-rear direction, corresponding to the two rows of the rigid substrates 110. Each of the water cooling blocks 610 extends along the left-right direction. With this, it is possible to cool the power sources 112a each of which is positioned at the uppermost location of one of rigid substrates 110, of the rigid substrates 110, which are aligned so as to form one row of the two rows, at a time with one piece of the water cooling block 610, thereby making it possible to contribute in reducing the footprint of the cooler 600.

In the above-described embodiment, the relay substrate 300 is provided with the 12 first connectors 301 (an example of a “connector” of the present disclosure). Further, the rigid substrate 110 is inserted into the first connector 301 to be insertable/detachable with respect to the first connector 301 in the up-down direction (an example of the “inserting/detaching direction” of the present disclosure). Further, the water cooling block 610 of the cooler 600 is configured to be separated away from the rigid substrate 100 along the front-rear direction which crosses the left-right direction and the up-down direction. Since the rigid substrate 110 can be inserted and detached with respect to the first connector 301 in a state that the water cooling block 610 is separated away from the rigid substrate 110, it is possible to easily perform the insertion or the detachment of the rigid substrate 110 with respect to the first connector 301 in a case, for example, of performing maintenance for the rigid substrate 110.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below.

The embodiment disclosed herein is an example in all senses, and should be interpreted as non-restrictive or non-limiting in any way. All of the respective configurations described in the above-described embodiment are not necessarily indispensable, and the respective configurations can be changed or omitted as necessary.

In the above-described embodiment, the inserting/detaching direction of the rigid substrate 110 is the up-down direction, and the separating direction of the water cooling block 610 is the front-rear direction orthogonal to the up-down direction. The present disclosure, however, is not limited to or restricted by such an aspect; it is not necessarily indispensable that the inserting/detaching direction is parallel to the up-down direction. Further, it is allowable that the separating direction crosses the inserting/detaching direction; it is not necessarily indispensable that the separating direction and the inserting/detaching direction are orthogonal to each other.

In the above-described embodiment, the number of the head assembly 10 is 3 (three). The present disclosure, however, is not limited to such an aspect; the number and/or the position of the head assembly 10 may be changed as appropriate. Similarly, the number and/or the position of the head 11 included in one head group 20 may be changed as appropriate. Further, the number and/or the position of the nozzle 11a included in each of the heads 11 may be changed as appropriate. Furthermore, in the above-described embodiment, although the controller 7 is provided on the printing apparatus 1, the present disclosure is not limited to such an aspect. The controller 7 may be provided, for example, on the head assembly 10. Moreover, in the above-described embodiment, although the non-volatile memory 11m is provided on each of the heads 11, it is allowable that the non-volatile memory 11m is provided, for example, on the rigid substrate 110, or that the non-volatile memory 11m is provided on the controller 7.

In the above-described embodiment, although the cooler 600 is provided with the water cooling block 610, it is not necessarily indispensable that the water cooling block 610 has a block-like shape. For example, it is also possible to use a water cooling tube, instead of using the water cooling block 610.

In the above-described embodiment, a recording medium wound in a roll shape (for example, roll paper, roll paper sheet) is used as the recording medium 4. The present disclosure, however, is not limited to such an aspect; it is allowable to use a recording medium 4 having an appropriate shape and a material of an appropriate quality (characteristic, property), as necessary. In the above-described embodiment, the configuration, shape, material, etc., of the tank 40 can be changed as appropriate. For example, the printing apparatus 1 of the above-described embodiment is provided with the three head assemblies 10 and is configured to discharge the inks of five colors which are the white ink, the cyan ink, the magenta ink, the yellow ink and the black ink. The present disclosure is not limited to such an aspect; the printing apparatus 1 can be configured to discharge an ink of an appropriate color. Further, in the present disclosure, the UV-curable ink is used. The present disclosure, however, is not limited to such an aspect; it is also possible to use an ink different from the UV-curable ink (for example, a water-based ink, a pigment ink, etc.).

Further, the present disclosure is not necessarily limited to the head assembly including a line head; the present disclosure is widely applicable to a head assembly including a plurality of heads. Furthermore, the present disclosure is not limited to the printing apparatus of the ink-jet system which is configured to discharge or eject an ink. Moreover, the present disclosure is also applicable to a printing apparatus which is usable in a variety of kinds of usage or application other than printing an image, etc. For example, it is possible to apply the present disclosure also to a printing apparatus configured to form a conductive pattern on a surface of a substrate by discharging a conductive liquid onto the surface of the substrate. The scope of the present disclosure is intended to encompass all the changes within the scope of the claims and a scope equivalent to the scope of the claims.

What is claimed is:

1. A method for controlling a head assembly which includes:
a head including a plurality of pressure generators each of which includes one of a plurality of individual electrodes;
a substrate including a plurality of power sources mounted thereon so that at least power sources, as a part of the plurality of power sources, are located to be dispersed in an up-down direction, the substrate being electrically connected to the head; and
a cooler configured to cool an uppermost power source which is included in the plurality of power sources and which is positioned at an uppermost location among the plurality of power sources, wherein
a connection destination of each of the plurality of individual electrodes included in one of the plurality of pressure generators being one of the plurality of power sources,
the method comprising causing a memory provided on the head assembly or a memory provided on a controller electrically connected to the head assembly to store the connection destination of each of the plurality of individual electrodes, wherein
the causing the memory to store the connection destination of each of the plurality of individual electrodes includes, in a case that the plurality of individual electrodes is divided into a plurality of groups each corresponding to the connection destination thereof, making the connection destination corresponding to a group, of the plurality of groups, including individual electrodes, of which number is greatest among the plurality of individual electrodes, to be the uppermost power source which is included in the plurality of power sources and which is positioned at the uppermost location among the plurality of power sources.

2. The method according to claim 1, wherein
the causing the memory to store the connection destination of each of the plurality of individual electrodes includes making the connection destination corresponding to a group, of the plurality of groups, including individual electrodes, of which number is second greatest among the plurality of individual electrodes, to be a lowermost power source which is included in the plurality of power sources and which is positioned at a lowermost location among the plurality of power sources.

3. The method according to claim 2, wherein
the causing the memory to store the connection destination of each of the plurality of individual electrodes includes making the connection destination corresponding to a group, of the plurality of groups, including individual electrodes, of which number is third greatest among the plurality of individual electrodes, to be a power source which is included in the plurality of power sources and which is positioned between the uppermost power source and the lowermost power source.

4. A system comprising:
a head assembly;
a controller electrically connected to the head assembly; and
a memory, wherein
the head assembly includes:
a head including a plurality of pressure generators each of which includes one of a plurality of individual electrodes;
a substrate including a plurality of power sources mounted thereon so that at least power sources, as a part of the plurality of power sources, are positioned to be dispersed in an up-down direction, the substrate being electrically connected to the head; and
a cooler configured to cool an uppermost power source which is included in the plurality of power sources and which is positioned at an uppermost location among the plurality of power sources,
a connection destination of each of the plurality of individual electrodes included in one of the plurality of pressure generators is one of the plurality of power sources,
the controller is configured to execute causing the memory to store the connection destination of each of the plurality of individual electrodes, and
the controller executing the causing the memory to store the connection destination of each of the plurality of individual electrodes includes, in a case that the plurality of individual electrodes is divided into a plurality of groups each corresponding to the connection destination thereof, includes the controller making the connection destination corresponding to a group, of the plurality of groups, including individual electrodes, of which number is greatest among the plurality of individual electrodes, to be the uppermost power source which is included in the plurality of power sources and which is positioned at the uppermost location among the plurality of power sources.

5. The system according to claim 4, wherein
the controller executing the causing the memory to store the connection destination of each of the plurality of individual electrodes includes the controller making the connection destination corresponding to a group, of the plurality of groups, including individual electrodes, of which number is second greatest among the plurality of individual electrodes, to be a lowermost power source which is included in the plurality of power sources and which is positioned at a lowermost location among the plurality of power sources.

6. The system according to claim 5, wherein
the controller executing the causing the memory to store the connection destination of each of the plurality of individual electrodes includes the controller making the connection destination corresponding to a group, of the plurality of groups, including individual electrodes, of which number is third greatest among the plurality of individual electrodes, to be a power source which is included in the plurality of power sources and which is positioned between the uppermost power source and the lowermost power source in the up-down direction.

7. The system according to claim 4, wherein
a heating member of which heating value is greater than a heating value of each of the plurality of power sources is mounted on the substrate, and
the cooler is configured to cool the heating member.

8. The system according to claim 7, wherein
the cooler includes one cooling part which is configured to commonly cool the uppermost power source and the heating member.

9. The system according to claim 7, wherein
the heating member is located above the uppermost power source.

10. The system according to claim 9, wherein
the plurality of pressure generators includes at least one common electrode, and
the heating member is a power source, among the plurality of power sources, which is connected to the at least one common electrode.

11. The system according to claim 4, wherein
the head assembly includes:
a head group including a plurality of heads each of which is the head; and
a substrate group including a plurality of substrates each of which is the substrate,
the cooler includes one cooling part configured to commonly cool a plurality of uppermost power sources each of which belongs to one of the plurality of the substrates included in the substrate group.

12. The system according to claim 11, wherein
a plurality of heating members of which heating value is greater than heating values of the plurality of power sources is mounted on the plurality of the substrates included in the substrate group, and
the cooling part is configured to commonly cool the heating members and the plurality of the uppermost power sources each of which belongs to one of the plurality of the substrates included in the substrate group.

13. The system according to claim 12, wherein
the plurality of substrates included in the substrate group is aligned in a row along a first direction crossing the up-down direction, and
the cooling part includes a water cooling tube or a water cooling block extending along the first direction.

14. The system according to claim 13, wherein
the plurality of the substrates included in the substrate group is aligned along the first direction so as to construct two rows arranged side by side along a second direction crossing the first direction, and
the cooling part is configured to commonly cool the plurality of the heating members and the plurality of the uppermost power sources each of which belongs to one of the plurality of the substrates included in the substrate group and arranged side by side so as to form the two rows.

15. The system according to claim 13, wherein
the head assembly includes a connector configured so that each of the plurality of the substrates is insertable into the connector along an inserting/detaching direction crossing the first direction.

16. The system according to claim 15, wherein
the cooling part is configured to be separated with respect to the plurality of the substrates along a separating direction orthogonal to the first direction and the inserting/detaching direction.

17. A printing apparatus comprising:
the system as defined in claim 4; and
a conveyor configured to convey a recording medium.

18. Ahead assembly comprising:
a head including a plurality of pressure generators each of which has one of a plurality of individual electrodes;
a substrate including a plurality of power sources mounted thereon so that at least power sources, as a part of the plurality of power sources, are positioned to be dispersed in an up-down direction, the substrate being electrically connected to the head; and
a cooler configured to cool an uppermost power source which is included in the plurality of power sources and which is positioned at a uppermost location in the plurality of power sources, wherein
a connection destination of each of the plurality of individual electrodes included in one of the plurality of pressure generators is one of the plurality of power sources, and
the uppermost power source which is included in the plurality of power sources and which is positioned at the uppermost location among the plurality of power sources is a power source of which heating value is greatest among the plurality of power sources.

19. The head assembly according to claim 18, wherein
a power source, among the plurality of power source, of which heating value is second greatest among the plurality of power sources, is located at a lowermost location among the plurality of power sources.

20. The head assembly according to claim 19, wherein
a power source, among the plurality of power source, of which heating value is third greatest among the plurality of power sources, is located at a position, in the up-down direction, between the power source of which heating value is greatest and the power source of which heating value is second greatest among the plurality of power sources.

21. The head assembly according to claim 18, wherein
a heating member of which heating value is greater than heating values of the plurality of power sources is mounted on the substrate, and
the cooler is configured to cool the heating member.

22. The head assembly according to claim 21, wherein
the cooler includes one cooling part configured to commonly cool the uppermost power source and the heating member.

23. The head assembly according to claim 21, wherein
the heating member is located above the uppermost power source.

24. The head assembly according to claim 23, wherein
the plurality of pressure generators includes at least one common electrode, and
the heating member is a power source, of the plurality of power sources, which is connected to the at least one common electrode.

25. The head assembly according to claim 18, further comprising:
a head group including a plurality of heads each of which is the head; and
a substrate group including a plurality of substrates each of which is the substrate, wherein
the cooler includes a cooling part configured to commonly cool a plurality of uppermost power sources each of which belongs to one of the plurality of the substrates included in the substrate group.

26. The head assembly according to claim 25, wherein
a plurality of heating members of which heating value is greater than heating values of the plurality of power sources is mounted on the plurality of substrates included in the substrate group, and
the cooling part is configured to commonly cool the heating members and the plurality of the uppermost power sources each of which belongs to one of the plurality of the substrates included in the substrate group.

27. The head assembly according to claim 26, wherein
the plurality of substrates included in the substrate group is aligned in a row along a first direction crossing the up-down direction, and
the cooling part includes a cooling water tube or a water cooling block extending along the first direction.

28. The head assembly according to claim 27, wherein
the plurality of substrates included in the substrate group is aligned along the first direction so as to construct two rows arranged side by side along a second direction crossing the first direction, and
the cooling part is configured to commonly cool the plurality of heating members and the plurality of uppermost power sources each of which belongs to one of the plurality of substrates included in the substrate group and arranged side by side so as to form the two rows.

29. The head assembly according to claim 27, wherein
the head assembly includes a connector configured so that each of the plurality of substrates is insertable into the connector along an inserting/detaching direction crossing the first direction.

30. The head assembly according to claim 29, wherein
the cooling part is configured to be separated with respect to the plurality of the substrates along a separating direction orthogonal to the first direction and the inserting/detaching direction.

31. The head assembly according to claim 18, wherein
the power source of which heating value is greatest among the plurality of power sources is a power source, among the plurality of power sources, which is connected to individual electrodes which are included in the plurality of individual electrodes and of which number is greatest among the plurality of individual electrodes.

32. A printing apparatus comprising:
the head assembly as defined in claim 18; and
a conveying mechanism configured to convey a recording medium.
